(19) United States
(12) Patent Application Publication
(10) Pub. No.: US 2010/0263226 A1
(43) Pub. Date: Oct. 21, 2010

(54) WASHING/DRYING DEVICE COMPRISING A MOISTURE DETERMINING DEVICE AND METHOD FOR OPERATING A WASHING/DRYING DEVICE

(75) Inventors: Pilar Balerdi Azpilicueta, Barindano (Navarra) (ES); Iñigo Berazaluce Minondo, Spanien (ES); Esther Padilla Lopez, Estella (ES); Roberto San Martin Sancho, Estella (ES)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/746,774

(22) PCT Filed: Dec. 5, 2008
(86) PCT No.: PCT/EP08/66865

§ 371 Date: Jun. 8, 2010

(30) Foreign Application Priority Data
Dec. 20, 2007 (DE) 10 2007 061 519.3

(51) Int. Cl. F26B 3/02; D06F 58/04; F26B 21/08; F26B 21/06; F26B 19/00

(52) U.S. Cl. 34/475; 34/130; 34/557; 34/72; 34/549

(57) ABSTRACT

A laundry drying device having a washing drum; a moisture determining device to determine a moisture content of process air evacuated from the washing drum, wherein the moisture determining device has at least one temperature sensor; and a cooling body to cool the process air, wherein the cooling body has an inlet side, an outlet side, and an inlet for a medium that flows through the cooling body or that is located in the cooling body. A first temperature sensor is arranged behind the inlet of the cooling body; a second temperature sensor is arranged at the outlet side of the cooling body to measure an outlet temperature of the medium; and a third temperature sensor is arranged at the inlet side of the cooling body to measure an inlet temperature of the medium. The medium is the process air or a coolant.

The invention relates to a laundry drying device comprising a moisture determining device for determining moisture content of process air evacuated from a washing drum, and to a method for operating a laundry drying device of this kind.

A laundry drying device comprising a washing drum, a moisture determining device for determining moisture content of process air evacuated from the laundry drum and comprising a cooling body for cooling the process air is generally known. Water condensed from the process air is captured in a container for liquid or removed via a water outlet. Laundry drying devices are known in this connection which are called condensing dryers and comprise a cooling body which is filled with a coolant prior to commissioning of the laundry drying device. This is preferably mains water which is let into a cooling body and is replenished if required.

There are also laundry drying devices which comprise a heat pump to condense process air moisture content. Such heat pumps consist in particular of a compressor or condenser for condensing a coolant and of an evaporator for evaporating the coolant. Process air that has passed the evaporator is cooled accordingly, so moisture contained therein is at least partially condensed.

Such laundry drying devices are designed for drying laundry and are controlled by means of a controller such that they can capture any remaining moisture in the laundry in order to automatically stop the drying process if sufficient drying has been achieved. The drying period and accordingly power consumption can be reduced as a result. To enable this, laundry drying devices of this kind are equipped with a moisture determining device which, in the form of a moisture sensor connected to the controller, measures moisture directly in the process air leaving the washing drum. Appropriate moisture sensors are available in different designs and with different technologies depending on the manufacturer. Such moisture sensors always measure the moisture or moisture content of process air evacuated from the laundry drum directly, however. One drawback in this connection is that the moisture sensors are components that are complex to produce, and are accordingly cost-intensive.

It is the object of the present invention to improve a laundry drying device comprising a moisture determining device and a method for operating a laundry drying device of this kind in such a way that constructionally simpler and consequently, with regard to costs, more reasonable, components can be used.

This object is achieved by a laundry drying device comprising a moisture determining device and the additional features as claimed in claim 1 and by a method for operating a laundry drying device according to the features as claimed in claim 14. Advantageous embodiments are the subject matter of dependent claims in particular.

A laundry drying device comprising a washing drum, a moisture determining device for determining the moisture content of process air evacuated from the laundry drum and comprising a cooling body for cooling the process air, with the moisture determining device comprising at least one temperature sensor, is preferred therefore. An arrangement of this kind means that use of an expensive moisture sensor can be avoided as at least one temperature sensor for indirectly determining the moisture content is used instead of a moisture sensor for direct measurement of moisture content. A service life of the sensor(s) can, moreover, be achieved compared with a moisture sensor. In contrast to dedicated moisture sensors, the temperature sensors do not need to be cooled and the detection accuracy is increased.

The at least one temperature sensor is arranged behind a coolant inlet for a medium that flows through the cooling body (for example process air or coolant) or for a medium located in the cooling body (for example coolant). With such an arrangement it was already possible for the process air to transfer latent heat to the coolant, so moisture could be condensed out of the process air.

It is preferred for the at least one temperature sensor for measuring a temperature of the process air to be arranged at the outlet side of the cooling body. When measuring the temperature of the process air, ‘outlet side of the cooling body’ can be taken to mean both that the temperature sensor is still arranged inside a cooling section of the cooling body and, preferably, also that the temperature sensor is arranged outside and behind a cooling section of the cooling body. It is important for the process air to already be able to transfer at least so much latent heat to the coolant such that moisture could condense out of the process air. The use of one such temperature sensor is sufficient since overheating of the clothes to be dried does not usually need to be of concern, as long as these are still wet and the process air is enriched with moisture preferably up to saturation point.

The at least one temperature sensor is arranged in particular behind a coolant inlet of the cooling body for measuring a temperature of a coolant flowing through the cooling body (for example in the case of a heat exchanger).

Additionally or alternatively the at least one temperature sensor can be arranged behind a coolant inlet of the cooling body for measuring a temperature of a coolant located in the cooling body (for example in the case of some water-cooled cooling bodies). When measuring the temperature of the coolant ‘outlet side of the coolant’ may be taken to mean both that the temperature sensor is still preferably arranged inside a cooling section of the cooling body, and that the temperature sensor is arranged outside and behind a cooling section of the cooling body. Again it is crucial for the process air behind a, relative thereto, inlet-side temperature sensor to be able to transfer so much latent heat to the coolant that moisture could be condensed out of the process air. An arrangement of this kind may be designed as a heat pump in which a coolant flows through an evaporator. An embodiment in what is known as a condensing dryer is also possible, in which a coolant, for example mains water, is let into a cooling body as required.

The moisture determining device is preferably configured and/or programmed to determine the moisture content using a temporal sequence of temperatures measured by means of the temperature sensor.

The moisture determining device is in particular configured and/or programmed to determine an—based on the cooling body—inlet-side increase and/or an outlet-side drop in temperature of the process air or coolant using the temporal sequence of measured temperatures of the process air compared with a previous temperature plateau value of the process air or the coolant. As long as the process air is conveyed to the cooling body with a consistent moisture content, the cooling body draws a consistent quantity of moisture from the process air. Accordingly, the measurable temperatures are substantially constant. With a reduction in the moisture content in the process air owing to clothes becoming drier in the laundry drying device, the process air then gives off not just latent heat but increasingly more sensible heat to the coolant, however. When measuring the temperature of the process air a reducing moisture content of the process air may be deduced from a drop in the temperature at, in particular, the outlet of the evaporator or cooling body over time. When measuring the temperature of the coolant a reducing moisture content of the process air can accordingly be deduced from an increase in the temperature over time. The temperature difference between inlet-side temperature and outlet-side temperature of the cooling body can also be detected and used to establish moisture content (degree of dryness)). This can preferably take place by means of reference to a temperature difference plateau value but also in absolute values of the temperature difference (for example by exceeding or falling below a temperature difference threshold value).

Owing to variations due to devices and methods, the temperature plateau value should be taken to mean an average value of a sequence of individual successive measured values respectively. Accordingly, threshold values may also be fixed, the exceeding or falling below of which is used as an indicator for a drop in the process air temperature or an increase in the coolant temperature.

The at least one temperature sensor can be arranged at the outlet side of the cooling body for measuring a temperature of the process air and a further temperature sensor can be arranged at the inlet side of the cooling body for measuring an inlet temperature of the process air. According to a further embodiment the at least one temperature sensor can be arranged behind a coolant inlet of the cooling body for measuring a temperature of a coolant flowing through the cooling body or a coolant located in the cooling body, and a further temperature sensor can then be arranged at the inlet side of the cooling body for measuring an inlet temperature of the coolant. According to corresponding embodiments that can also be used in combination, two measured values of the process air or the coolant are consequently provided in the region of the inlet or in the region of the outlet of the cooling body, the difference value of which provides a more accurate measure for determining the dehumidifying output of the cooling body. Indirectly, moisture content of the process air flowing out of the laundry drum can accordingly also be deduced more accurately than in the case of just a single, in particular outlet-side, temperature sensor.

The cooling body is preferably dimensioned and/or a controller is preferably configured and/or programmed for coolant to flow through the cooling body such that, up to the at least one temperature sensor, not all of the moisture content is drawn from the process air.

The cooling body can in particular be formed by an evaporator of a heat pump.

The at least one temperature sensor is preferably a sensor of a heating device controller for controlling a process air temperature. A temperature sensor that conventionally already exists can therefore be used particularly advantageously, so it is possible not only for a moisture sensor to be omitted, but, in the simplest embodiment, an additional temperature sensor does not even have to be used.

A method for operating a laundry drying device is accordingly independently advantageous in which moisture content of process air evacuated from a laundry drum is determined and in which the moisture is at least partially condensed out of the process air by a cooling body, the moisture determination being ascertained by measuring at least one temperature and by evaluating the measured temperature.

A temperature difference between a temperature measured at the outlet-side of the cooling body and a temperature measured at the inlet-side of the cooling body is preferably formed for moisture determination.

The moisture content is preferably determined using a temporal sequence of measured temperatures or temperature differences. In particular, a decreasing moisture content is indicated in the case of an inlet-side increase and/or and outlet-side drop in temperature of the process air using the temporal sequence of measured temperatures or temperatures differences of the process air compared with a previous temperature or temperature difference plateau value of the process air. Additionally or alternatively a decreasing moisture content of the process air may also be indicated in the case of an inlet-side drop and/or outlet-side increase in the temperature of the coolant using the temporal sequence of measured temperatures of the coolant compared with a previous temperature plateau value of the coolant.

A laundry drying device of this kind or a method for operating a laundry drying device using method steps of this kind not only offers a reduction in costs due to the use of inexpensive temperature sensors instead of moisture sensors but surprisingly a longer device service life can also be achieved owing to the longer service life of the temperature sensors compared with moisture sensors. A further advantage lies in the fact that, in contrast to moisture sensors, such temperature sensors do not have to be cooled, and this further simplifies the construction and operating expenses. Surprisingly, a higher degree of accuracy can also be attained if an indirect measurement of this kind is carried out using measured temperatures instead of a direct moisture measurement.

Exemplary embodiments of the invention are described schematically in more detail below with reference to the drawings, in which:

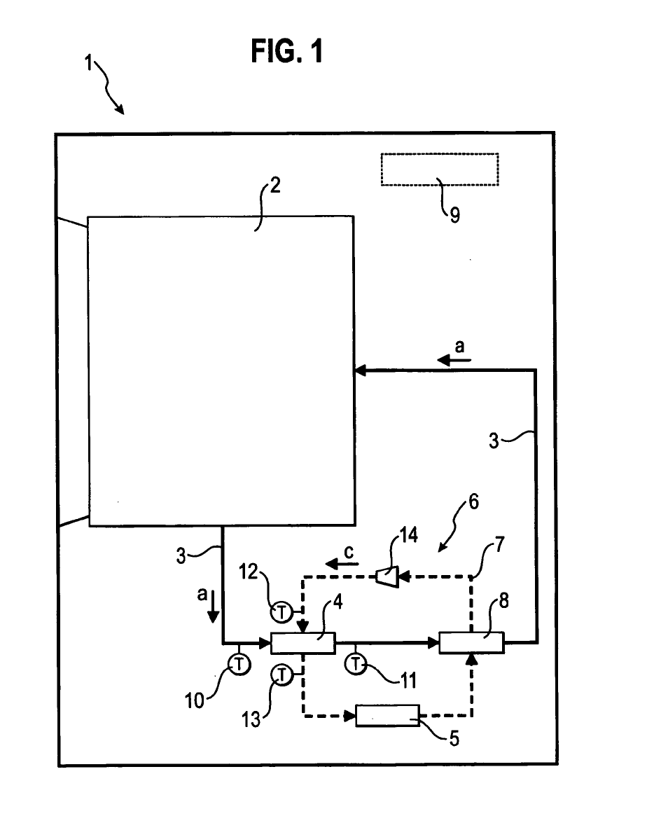

FIG. 1 shows a laundry drying device with components for forming a moisture determining device based on indirect temperature measurement;

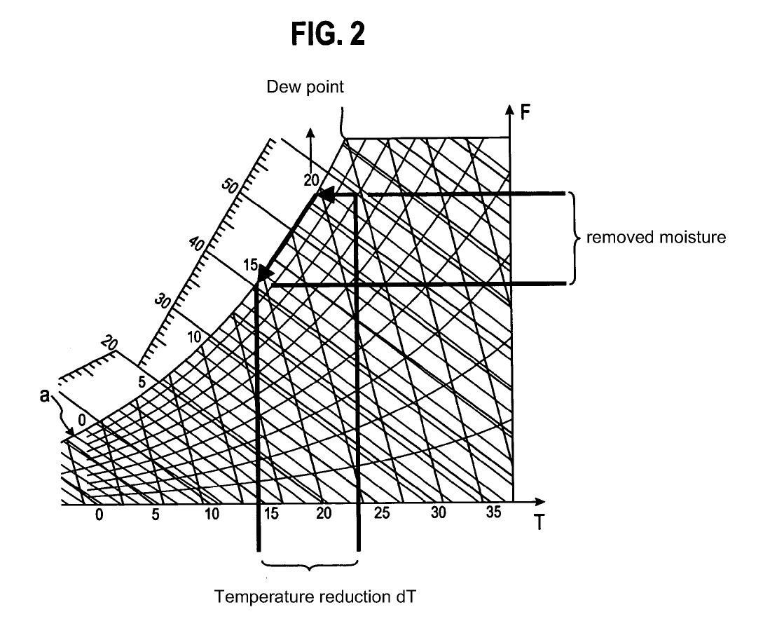

FIG. 2 shows a graph to illustrate a relationship of temperature of process air in relation to its moisture content;

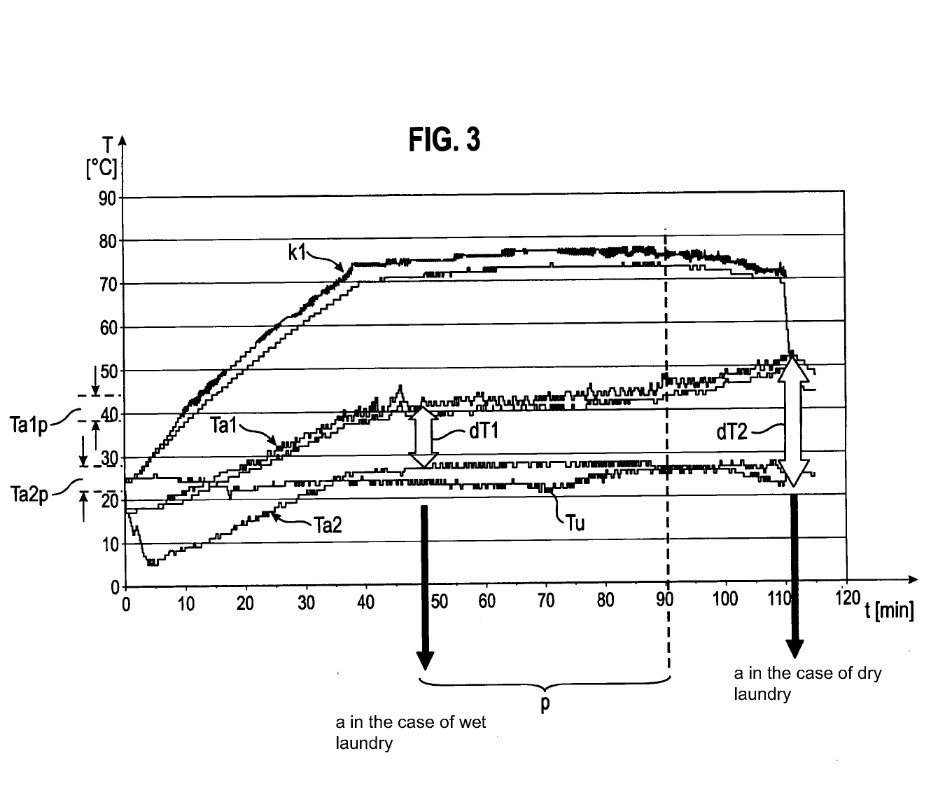

FIG. 3 shows a graph with a large number of temperature curves, in particular of process air in a laundry drying device according to FIG. 1, plotted over time;

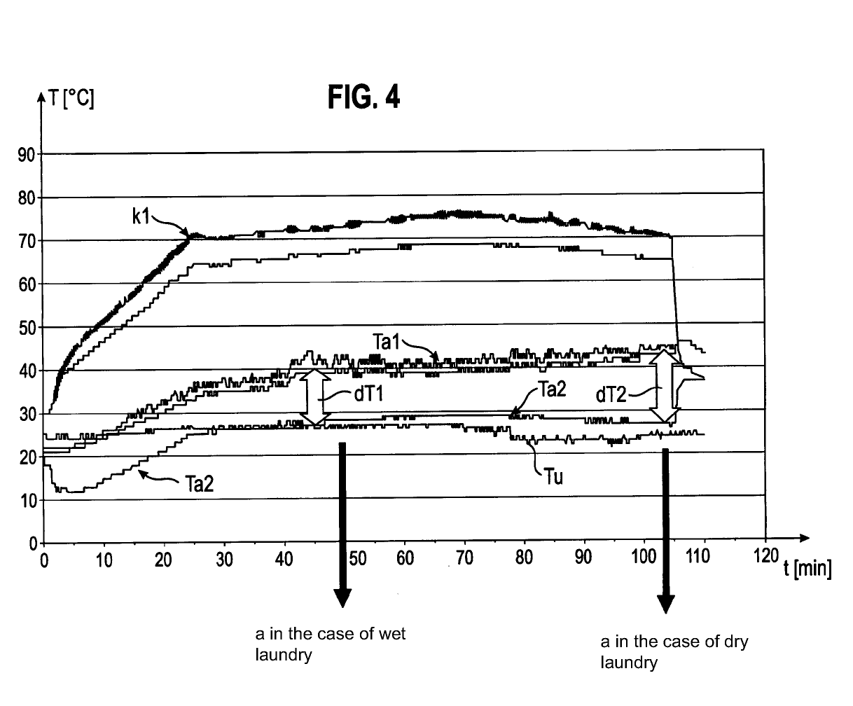

FIG. 4 shows a further graph of this kind when a heat exchanger with a lower efficiency compared with FIG. 3 is used; and

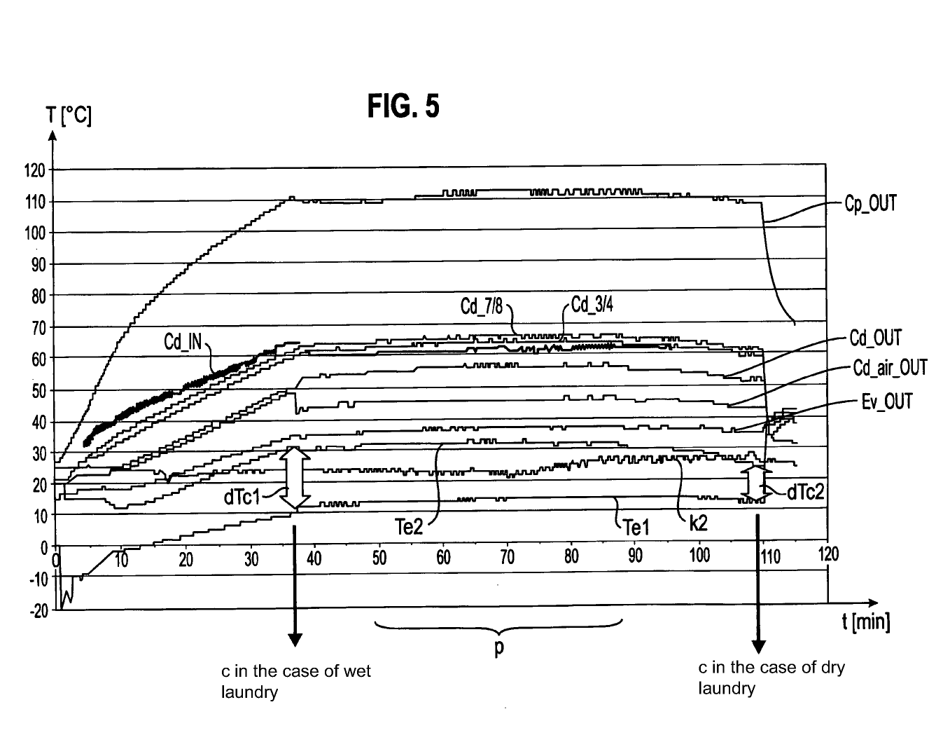

FIG. 5 shows a further graph in which curves of a coolant temperature are plotted over time.

FIG. 1 schematically shows a laundry drying device 1 comprising a laundry drum 2, which is fluidically coupled to a circulating air or process air duct 3. During a drying process heated process air a is typically blown out of the circulating air duct 3 and into the laundry drum 2 by means of a circulation fan (not shown here). There the process air absorbs moisture while giving off heat and is removed by suction from the laundry drum 2 again into the circulating air channel 3 and is firstly cooled there in order to at least partially condense. For cooling and condensing the process air a, a cooling body 4 is coupled into the circulating air duct 3, through which body the warm and moist exhaust air from the laundry drum 2 flows. A heater 8 is coupled into the circulating air duct 3 for subsequent heating of the cooled process air. After heating, the dry and warm process air is blown toward the laundry drum 2 again.

In the illustrated embodiment the cooling body is designed as an evaporator 4 and the heater as a condenser 8 of a heat pump 6. The heat pump 6 also comprises a compressor 5 and a throttle 14 which, as shown and basically known, are connected together in a circuit by means of a coolant conduit 7 transporting coolant c. In the condenser 8 the coolant c is brought from a gaseous state into a liquid state with heat being given off to the process air a. The coolant c is then conveyed into the evaporator 4 in which it is evaporated. The evaporator 4 accordingly draws heat from the process air a, so moisture is condensed out of the process air a. Moisture condensed in this way is either outwardly removed from the device or captured in a condensate container (not shown). An additional heater, for example an electric heater, can optionally be connected downstream of the heat pump or the condenser 8 (no diagram).

A laundry drying device 1 of this kind comprises a controller 9 for controlling various functions thereof. The controller 9 is in particular configured and/or programmed to determine moisture content in the process air a in order to control ongoing operation independently of moisture content, in particular heating of the process air and operating time of a drying process.

The laundry drying device 1 is also equipped with a moisture determining device to which, in addition to the appropriately configured and/or programmed controller 9, at least one temperature sensor 11 or preferably two or more temperature sensors 10-13 belong. A corresponding temperature Ta1, Ta2 of the process air a or a temperature Te1, Te2 of the coolant c is measured by means of the temperature sensors 10-13. To put it more precisely, a first temperature sensor 10 is integrated in the circulating air duct 3 at the inlet side (upstream) of the evaporator 4 and this senses a temperature Ta1; a second temperature sensor 11 is integrated in the circulating air duct 3 at the outlet side (downstream) of the evaporator 4 and this senses a temperature Ta2; a third temperature sensor 12 is integrated in the coolant conduit 7 at the inlet side (upstream) of the evaporator 4 and this senses a temperature Te1 and a fourth temperature sensor 13 is integrated in the coolant conduit 7 at the outlet side (downstream) of the evaporator 4 and this senses a temperature Te2. The temperatures or corresponding temperature signals are fed to the controller 9 in order to thus deduce the moisture content of the process air a from a temperature measurement using an indirect procedure.

While these positions for the temperature sensors 10, 11 are particularly preferred, in principle any other positions within the evaporator 4 or in the air duct 3 spaced apart from the evaporator 4 may also be chosen, however, as long as there is at least one part of the condensing section of the evaporator 4 located between these temperature sensors 10, 11. As, conventionally, at least one temperature sensor is arranged in the air duct 3 for measuring the temperature of the process air a, to enable the drying cycle to be controlled, accordingly only one additional temperature sensor needs to be arranged in the circulating air duct 3, and this is significantly less expensive than providing a moisture sensor that measures the moisture content directly.

According to an alternative embodiment, albeit with a slightly less accurate measuring result, a measurement may also be carried out using just a single temperature sensor, namely temperature sensor 11 here for measuring the temperature Ta2 of the process air a at the outlet side of the evaporator 4.

The coolant temperature sensors 12, 13 can be used as alternatives or in addition, as is described in more detail further below.

Using a physiometric graph FIG. 2 shows the relationship of moisture content F to the temperature T of process air a. A dew point of the process air a is depicted by way of example. The higher the temperature T, the higher the moisture content F if maximum moisture is assumed. The process air a loses moisture accordingly as it is cooled, so some of the moisture content is removed in accordance with the temperature reduction dT.

Using at least one temperature measurement it may accordingly be established to what extent the moisture content has been reduced in or at the cooling body 4 of a laundry drying device.

If a laundry drying device with a heat pump 6 is used, for example according to FIG. 1, an indirect measurement of the moisture content in the process air a can advantageously be determined using the properties of such a heat pump 6. Two basically different types of measurement will be considered here.

If a drying process is started and the laundry in the laundry drum 2 is full of moisture, the process air a, which is let into the laundry drum 2, absorbs a quantity of the moisture, ideally a quantity of moisture up to the saturation limit, according to FIG. 2. The process air a accordingly leaves the laundry drum 2 with a high moisture content. This process air a with the high moisture content is conveyed to the evaporator 4 of the heat pump 6 and cooled there. Due to cooling of the process air a at the evaporator 4, water or moisture has to condense out of the process air a as soon as it reaches dew point and saturation with moisture exists accordingly.

If the process air a is cooled further along the dew point, heat exchange takes place in or with the evaporator 4. The exchanged heat consists of latent heat for condensing the water and sensible heat for cooling the temperature of the process air a or for heating the coolant c in the evaporator 4. At the start of a drying inflow, when the moisture in the process air a is high, the latent heat in the evaporator 4 is much higher than the sensible heat. As the moisture in the process air a decreases the percentage or fraction of sensible heat increases relative to the latent heat fraction.

At the start of a drying process the process air is heated over time. The moisture content of the process air accordingly increases as time goes on, until a balance is established and a substantially constant temperature can be measured at various positions of the circulating air duct 3, until the laundry to be dried dries and gives off less moisture to the process air a. If the process is stable and a constant air flow of process air a and a constant heat exchange are attained in the evaporator 4, the temperature exchange of the process air a in the evaporator 4 is higher while the sensible heat is high or increases until ultimately the moisture or moisture content in the process air a decreases at the outlet of the laundry drum 2.

When the process air a leaves the laundry drum 2 an indirect measurement of the moisture content of the process air a can accordingly be carried out, as a result of a measurement of the temperature of the process air a at the inlet and outlet of the evaporator 4. By determining corresponding temperature values the controller 9 can deduce the moisture content of the process air a and control the drying cycle of the cooling/drying device 1 in coordination therewith.

In the embodiment of FIG. 1 with the two temperature sensors 10, 11 at the inlet side or outlet side of the evaporator 4, the controller 9 compares whether and/or by what amount the temperature Ta1 measured at the inlet side of the evaporator 4 is smaller than the temperature Ta2 measured at the outlet side, and a difference between these values is determined and/or evaluated. Adequate dryness can be detected for example by a predetermined difference temperature threshold value being exceeded (absolute value), or a change in the difference temperature in relation to the difference temperature at a plateau p over time exceeding a certain magnitude (relative value).

By contrast, in the alternative second embodiment with just the one temperature sensor 11, the controller 9 preferably checks to what extent a temperature Ta2(t) of the process air a measured over time develops and can determine sufficient drying for example from a plateau value, previously averaged over time, being exceeded by a certain amount. If the moisture content decreases after a time of conditions that keep the values constant, less latent heat and more sensible heat is absorbed by the process air a in the evaporator 4. The temperature of the process air in the evaporator 4 then decreases more and more accordingly. By way of suitable programming the controller 9 can accordingly detect that, measured over time, the temperature Ta2(t) of the process air a is decreasing at the outlet side of the evaporator 4 and therefore the moisture content of the process air is decreasing. This effect cannot be so accurately determined compared with the first embodiment, however, as changes in process and surroundings cannot be easily compensated. Therefore, during the decrease in moisture content in the process air a, with the same heating power for subsequent heating of the process air a, the latter enters the laundry drum 2 at a reduced temperature as well and can accordingly absorb less moisture from the already partially dried laundry. With appropriate countermeasures the fraction of heat which is transferred by the process air a to the partially dried laundry also changes as the moisture content in the process air decreases, and this ultimately allows the temperature of the process air a at the outlet of the laundry drum 2 to increase during the drying cycle. This can in turn be compensated by more sensitive cooling in the evaporator 4 with a reduced moisture content.

FIG. 3 shows by way of example a drying cycle in a laundry drying device 1 according to FIG. 1, temperature characteristics of the process air a being shown at various points in the air duct 3. The respective temperature T is plotted over the course of time t. As, for test purposes, two temperature sensors respectively were used at the respective measuring points, two measuring curves respectively are accordingly depicted for the respective temperature value at a single position. Curves K1 at the entry to the laundry drum 2 and exit of the condenser 8 achieve the highest temperature values. At the start of the drying cycle the process air a is still relatively cold during the first 40-50 minutes for example and is increasingly heated by the condenser 8 and optionally an additional heater, not shown, until a plateau value is reached in the region of a plateau p with constant operating conditions. The plateau p extends over a period of about 40 to 50 minutes to more than 90 minutes and matches the period during which substantially constant conditions prevail in the laundry drying device as a uniform quantity of moisture is given off by the laundry to the process air a and a uniform quantity of moisture is removed from the process air a in the evaporator 4. In the following time section, in which less moisture is given off to the process air a owing to increasing drying of the laundry, the laundry accordingly absorbs more heat, so the temperature k1 at the entry to the laundry drum 2 gradually decreases until the drying cycle has ended.

The temperature Ta1 of the process air a at the inlet side of the evaporator 4 and at the outlet side of the laundry drum 2 is also shown. This temperature T1a gradually increases until constant operating conditions or the plateau p is reached. At plateau p it attains a more or less constant temperature plateau value Ta1p. At the end of the plateau p, or in particular downstream of the plateau p, the temperature Ta1 gradually increases further as the degree of dryness of the clothes in the laundry drum 2 increases and the absorption of moisture by the process air a is less accordingly. In the illustrated example the temperature plateau value Ta1p lies in a range between almost 40° C. and 5° C.

Typically, no constantly fixed temperature plateau values are indicated or determined as the amount of clothes to be dried in the laundry drum 2 and their irregular rotation alone means that a different amount of moisture is constantly being transferred to the process air a. Threshold values surrounding such plateau values are preferably determined and considered accordingly by the controller 9 to take account of these natural conditions.

The temperature Ta2 of the process air a measured at the outlet side of the evaporator 4 is also shown. At the start of a drying cycle, when the process air has not yet absorbed a significant amount of moisture, the process air a is intensively cooled by the evaporator 4 and only after a few minutes does it decrease continuously until the plateau p temperature is reached. A temperature plateau value Ta2p of this temperature Ta2 at the outlet side of the evaporator 4 is about 25-30° C. If the laundry gives off increasingly less moisture to the process air a, the process air a is cooled increasingly more by the evaporator 4 again so the temperature Ta2 of the process air a at the outlet side of the evaporator 4 drops again or assumes lower values at the end of the plateau p.

An analysis of both the inlet side and outlet side temperatures Ta1 and Ta1 of the process air a at the evaporator 4 or cooling body 4 is preferably carried out accordingly. The difference between the individual temperature characteristics Ta1(t), ta2(t) over time can accordingly be evaluated by the controller 9 much more significantly than they can be analyzed. For the duration of the plateau p a temperature difference dT1 between the inlet and outlet-side temperatures Ta2−Ta1 is much lower than a temperature difference dT2 between these temperature values after the plateau p. The two temperature differences dT1, dT2 are shown by arrows in the graph.

The described effects also depend to a great extent on the quality of the heat exchanger or the heat pump 6. If a heat exchanger with low efficiency is used, the evaporator 4 cannot remove sufficient moisture from the process air a, so the moisture content is more stable during the drying cycle. If, in addition, some of the moisture content can escape to the surroundings, the effects on the temperatures in the region of the evaporator 4 are reduced further, so detection by the controller 9 is made more difficult. By way of example, a situation of this kind is shown with reference to FIG. 4. A laundry drying device with an optimally effective cooling body or evaporator 4 is preferred accordingly in order to be able to optimally recognize detection of the temperature variations over time or the temperature differences over time. The same reference characters as in FIG. 3 are used in FIG. 4, so reference is made to the statements made in relation to FIG. 3. In contrast to FIG. 3 it can be seen that the temperature differences are less pronounced and that the temperatures in the plateau region differ slightly from those according to FIG. 3.

According to a further aspect a heat exchange efficiency in the heat pump also depends on the relative moisture content of the process air a conveyed through the evaporator 4. In the case of an exemplary heat exchanger or its evaporator 4, the process air a with a relatively high moisture content has a better heat exchange efficiency. If during the drying cycle the moisture content decreases, the heat exchanger or heat pump has a decreasing heat exchange output accordingly.

The second type of measurement is based hereon. This effect can be seen particularly clearly in the region of the evaporator 4 as this then works at the dew point of the process air a. In the evaporator 4 the coolant c is transformed from the liquid to gaseous phase. A gaseous phase without liquid fractions must always exist at the outlet of the evaporator 4. During the actual phase change the temperature of the coolant c remains constant provided no conductive effects can be seen in the coolant or a large drop in pressure takes place. As soon as the coolant c has evaporated completely its temperature begins to increase. By acquiring or measuring the temperature Te1 of the coolant c at the inlet side of the evaporator and the temperature Te2 of the coolant c at the outlet side of the evaporator 4, or preferably at a point along the evaporator 4, an efficiency of the heat exchange may accordingly be determined. In accordance with the above statements this efficiency changes during the drying cycle.

The temperature sensors 12, 13, which are used to detect the temperature Te1 and Te2 of the coolant c at the inlet side and outlet side of the evaporator 4 respectively, are accordingly arranged spaced from each other on the pipe of the evaporator 4 or a corresponding connection pipe, the spacing preferably being less than the length of the effective region of the pipe of the evaporator 4. Instead of an evaporator a cooling body that can be used in an otherwise equivalent manner may of course also again be considered.

As the moisture content of the process air a decreases during the drying cycle the heat exchange or efficiency thereof becomes poorer, so the coolant is required for longer, i.e. has to flow through a longer section of the evaporator 4, to evaporate completely. The temperature difference or the temperature difference between a temperature sensor arranged at the inlet side and a certain point of a temperature sensor 13 that is arranged at the outlet side or at a spacing from the inlet side temperature sensor 12, will accordingly be lower. This can be taken as a measure of the moisture content of the process air a or the laundry still to be dried.

According to the preferred arrangement two temperature sensors 12, 13 are accordingly arranged on the cooling circuit, as a calculated difference dTc1, DTc2, illustrated in FIG. 5, of the temperatures Te2−Te1 of the coolant c at the outlet side or inlet side of the evaporator 4 has greater significance than an individual temperature value considered over time t. Use of two temperature sensors is still significantly more favorable with regard to construction and costs than providing a moisture sensor that measures moisture directly. According to a less preferred embodiment, however, measurement can also be implemented with just a single temperature sensor 13 in the region of the evaporator 4 or condenser 8.

The use of a laundry drying device 1, which has an optimally effective heat pump 6, is also preferred in these exemplary embodiments in which the temperature of the coolant c is used as a criterion for the moisture content of the process air a. If the evaporation output in the evaporator 4 were to be too low, the coolant c would assume a temperature very close to the temperature of the process air, so the effects would be concealed.

FIG. 5 shows by way of example a graph comparable with the graphs in FIG. 3 and FIG. 4. Temperature characteristics of the temperature T of the coolant c over time t are shown, however. Plateaus p can again be seen in a region in which constant operating conditions are adjusted. At the end of the plateau p the individual temperature characteristics increase or decrease more and more, however. The temperature difference dTc2 at the outlet side compared with the temperature difference dTc1 at the inlet side can again be seen particularly clearly. When considering the temperature of the coolant c the criterion for drying laundry is not an increase in the temperature differences dTc1, dTc2, however, but a decrease therein.

A temperature Te1 of the coolant c at the inlet side of the evaporator 4 is measured by the first of these temperature sensors 12 illustrated in FIG. 1, which detects the coolant temperature at the inlet side or in front of the evaporator 4. The second of these temperature sensors 13 for determining the temperature differences dTc1, dTc2 is arranged at three quarters of the length the evaporator 4 or its effective evaporator length.

Shown as additional exemplary temperatures are: a temperature Cp_OUT measured at the outlet of the compressor 8, temperatures Cd_3/4, Cd_7/8 at three quarters and seven eighths of the length of the condenser respectively, and a temperature Cd_OUT at the outlet of the condenser 8. For test purposes a circulating air temperature Cd_air_OUT at the outlet of the condenser, a temperature Cd_IN at the inlet of the compressor, an outlet-side temperature Ev_OUT at the evaporator and an ambient temperature K2 were also measured and illustrated.

Of course the present invention is not restricted to the described embodiment. Therefore detection of the degree of dryness by means of temperature sensing is also suitable for

condensers. The method can also be applied to both separate tumble dryers and to washer dryers.

### LIST OF REFERENCE CHARACTERS

1 laundry drying device
2 washing drum
3 air duct
4 cooling body
5 evaporator
6 heat pump
7 coolant conduit
8 condenser
9 controller
10-13 temperature sensors
14 throttle
a process air
c coolant
Cd_IN coolant temperature at the inlet side of the compressor
Cp_OUT coolant temperature at the outlet side of the compressor
Cd_{OUT} coolant temperature at the condenser outlet
Cd_3/4 coolant temperature at ¾ of the length of the condenser
Cd_7/8 coolant temperature at ⅞ of the length of the condenser
Cd_air_OUT circulating air temperature at the condenser
dT temperature reduction
dT1 process air temperature difference at the inlet side
dT2 process air temperature difference at the outlet side
dTc1 coolant temperature difference at the inlet side
dTc2 coolant temperature difference at the outlet side
Ev_OUT coolant temperature at the outlet side of the condenser
F moisture content
p plateaus
t time
T temperature
Ta1 temperatures of the process air at the inlet side
Ta2 temperatures of the process air at the outlet side
Ta2(t) temperature of the process air over time
Ta1p temperature plateau value of the process air at the inlet side
Ta2p temperature plateau value of the process air at the outlet side
Te1 temperatures of the coolant at the inlet side
Te2 temperatures of the coolant at the outlet side
Te2(t) temperature of the coolant over time
k1 temperature values at the entry to the washing drum
k2 ambient temperature

1-17. (canceled)

18. A laundry drying device, comprising:
a washing drum;
a moisture determining device to determine a moisture content of process air evacuated from the washing drum; the moisture determining device having at least one temperature sensor; and
a cooling body to cool the process air, the cooling body having an inlet side, an outlet side, and an inlet for a medium that is one of flowing through the cooling body and located in the cooling body;
wherein a first temperature sensor of the at least one temperature sensor is arranged behind the inlet of the cooling body;
wherein a second temperature sensor of the at least one temperature sensor is arranged at the outlet side of the cooling body to measure an outlet temperature of the medium;
wherein a third temperature sensor of the at least one temperature sensor is arranged at the inlet side of the cooling body to measure an inlet temperature of the medium; and
wherein the medium is one of the process air and a coolant.

19. The laundry drying device of claim 18, wherein the first temperature sensor is arranged at the outlet side of the cooling body to measure a temperature of the process air.

20. The laundry drying device of claim 18, wherein the cooling body has a cooling inlet; and wherein the at least one temperature sensor is arranged downstream of the coolant inlet of the cooling body to measure a temperature of the coolant that is one of flowing through the cooling body and located in the cooling body.

21. The laundry drying device of claim 18, wherein the moisture determining device is at least one of configured and programmed to determine the moisture content using a temporal sequence of temperatures measured by the at least one temperature sensor.

22. The laundry drying device of claim 21, wherein the moisture determining device is at least one of configured and programmed to determine at least one of an increase in the inlet temperature and a drop in the outlet temperature of the process air using the temporal sequence of measured temperatures of the process air in relation to a previous temperature plateau value of the process air.

23. The laundry drying device of claim 21, wherein the moisture determining device is at least one of configured and programmed to determine a drop in at least one of the inlet temperature and the outlet temperature of the coolant using the temporal sequence of measured temperatures of the coolant in relation to a previous temperature plateau value of the coolant.

24. The laundry drying device of claim 18, wherein the second temperature sensor is configured to measure the outlet temperature of the process air, and wherein the third temperature sensor is configured to measure the inlet temperature of the process air.

25. The laundry drying device of claim 18, wherein the moisture determining device is at least one of configured and programmed to determine a temperature difference in the inlet temperature and the outlet temperature of the medium.

26. The laundry drying device of claim 25, wherein the moisture determining device is at least one of configured and programmed to determine a temperature difference in the inlet temperature and the outlet temperature of the medium in relation to a temperature difference plateau value of the coolant.

27. The laundry drying device of claim 18, wherein the second temperature sensor to measure the outlet temperature of the coolant is arranged downstream of a coolant inlet of the cooling body, and wherein the third temperature sensor is configured to measure the inlet temperature of the coolant.

28. The laundry drying device of claim 18, wherein at least one of the cooling body is dimensioned and a controller is at least one of configured and programmed for the coolant to flow through the cooling body such that, up to the at least one temperature sensor, not all of the moisture content is drawn from the process air.

29. The laundry drying device of claim 18, wherein the cooling body comprises an evaporator of a heat pump.

30. The laundry drying device of claim 18, wherein the at least one temperature sensor is a sensor of a heating device controller to control a process air temperature.

31. A method for operating a laundry drying device, the method comprising:
determining moisture content from process air evacuated from a washing drum;
condensing moisture at least partially out of the process air with a cooling body;
determining the moisture by measuring at least one temperature of a medium that is one of flowing through the cooling body and located in the cooling body;
evaluating a measured temperature of the medium, wherein the medium is one of the process air and a coolant;
determining the moisture content by measuring an outlet temperature of the medium at an outlet side of the cooling body and by measuring an inlet temperature of the medium at an inlet side of the cooling body.

32. The method of claim 31, wherein the moisture content is determined using a temporal sequence of measured temperatures.

33. The method of claim 31, wherein a temperature difference between the outlet temperature and the inlet temperature is formed for moisture determination.

34. The method of claim 32, wherein a decreasing moisture content is indicated by one of an increase in the inlet temperature and a drop in the outlet temperature of the process air using the temporal sequence of measured temperatures of the process air in relation to a previous temperature plateau value of the process air.

35. The method of claim 32, wherein a decreasing moisture content of the process air is indicated by one of a drop in the inlet temperature and an increase in the outlet temperature of the coolant using the temporal sequence of the measured temperatures of the coolant in relation to a previous temperature plateau value of the coolant.

36. The method of claim 32, wherein a decreasing moisture content is indicated by one of an increase in a first temperature difference between the outlet temperature and the inlet temperature of the process air and a drop in a second temperature difference between the outlet temperature and the inlet temperature of the coolant using the temporal sequence of the respective temperature difference in relation to a previous temperature difference plateau value.
